(19) United States
(12) Patent Application Publication
(10) Pub. No.: US 2026/0133470 A1
(43) Pub. Date: May 14, 2026

(54) VARIABLE APERTURE ASSEMBLY AND LENS MODULE THEREOF

(71) Applicant: GUANGZHOU LUXVISIONS INNOVATION TECHNOLOGY LIMITED, Guangzhou City (CN)

(72) Inventors: Cheng-Te Tseng, Guangzhou City (CN); Sheng-Chieh Yang, Guangzhou City (CN)

(73) Assignee: GUANGZHOU LUXVISIONS INNOVATION TECHNOLOGY LIMITED, Guangzhou City (CN)

(21) Appl. No.: 19/308,502

(22) Filed: Aug. 25, 2025

(30) Foreign Application Priority Data
Nov. 8, 2024 (CN) 202411599026.2

(51) Int. Cl. G03B 9/06; G03B 7/26; G03B 30/00; H02N 2/04; H02N 2/06

(52) U.S. Cl. CPC G03B 9/06; G03B 7/26; H02N 2/046; H02N 2/06; G03B 30/00

(57) ABSTRACT

A variable aperture assembly and a lens module thereof are provided. The variable aperture assembly includes a base, a rotating plate, multiple blades, and two driving modules. The rotating plate is located between the base and the blades, the blades are connected to the rotating plate having two tracks, and the two tracks respectively correspond to the two driving modules. The two driving modules are configured to leveragingly drive the rotating plate to respectively rotate in opposite directions, to drive the blades to correspondingly move. Each driving module includes a driving member and a driven member. When the driving member is controlled to apply a pushing force to the driven member, a stress-bearing portion of the driven member correspondingly generates a restoring force. The pushing force and the restoring force cooperatively drive the driven member to contact one of the two tracks. Therefore, an aperture may be accurately adjusted.

### CROSS-REFERENCE TO RELATED APPLICATION

This non-provisional application claims priority under 35 U.S.C. § 119(a) to Patent Application No. 202411599026.2 filed in China on Nov. 8, 2024, the entire contents of which are hereby incorporated by reference.

### BACKGROUND

### Technical Field

The present disclosure relates to a camera element, and in particular, to a variable aperture assembly and a lens module thereof.

### Related Art

Generally, a mobile phone, a camera, or the like having a camera function controls an amount of light entering the photosensitive element in the device body through the aperture. The aperture is usually disposed on the lens, and by controlling the amount of light, imaging quality of the lens is further affected.

### SUMMARY

Because current market demands pursuit a mobile phone or a camera with a plurality of functions or high camera quality, a miniature lens module is configured in compact body space. The lens module provided with driving mechanism of a magnet and a voice coil motor may drive blades to move centripetally or move eccentrically, so as to control a size of an aperture hole. To precisely control the size of the aperture, the movement stroke of the blade is divided into a plurality of smaller segments. To improve imaging quality, the electronic product may be provided with more blades or with the blades having greater angular displacement capabilities. However, the driving force provided by the lens module would be too small, thereby limiting the functions of the camera.

In addition, in order to prevent the blades from moving in the opposite direction during movement, the lens module usually needs to be provided with a stop element, such as a stop ratchet. In this way, problems such as larger space required by the lens module or higher assembly costs are usually caused.

In view of this, in some embodiments, a variable aperture assembly is provided, including a base, a rotating plate, a plurality of blades, a first driving module, and a second driving module. The blades are annularly disposed on the base, and the rotating plate is located between the base and the blades. The blades are connected to the rotating plate, and the rotating plate has a first track and a second track. The first driving module corresponds to one of the first track and the second track of the rotating plate, and the second driving module corresponds to the other one of the first track and the second track. The first driving module and the second driving module are configured to leveragingly drive the rotating plate to respectively rotate in opposite directions, to drive the blades to correspondingly move. The first driving module and the second driving module each include a driving member and a driven member. The driving member and the driven member are disposed on the base. The driven member includes a stress-bearing portion fixed to the base. When the driving member is controlled to apply a pushing force to the driven member, the stress-bearing portion correspondingly generates a restoring force. The pushing force and the restoring force cooperatively drive the driven member to contact one of the first track and the second track.

In some embodiments, the driven member further includes a force-bearing portion and a resisting portion. The driving member applies the pushing force to the force-bearing portion. The resisting portion is connected to the force-bearing portion and the stress-bearing portion. The resisting portion is parallel to the rotating plate. The stress-bearing portion has a curved section. The curved section generates the restoring force. The pushing force and the restoring force cooperatively drive the resisting portion to have a start position and a contact position. When the resisting portion is located at the contact position, the resisting portion is in contact with one of the first track and the second track. When the resisting portion is located at the start position, a gap exists between the resisting portion and the rotating plate.

In some embodiments, one end of the curved section is extensively connected to the resisting portion, and the other end of the curved section is fixed to the base.

In some embodiments, the driving member includes a metal wire and a piezoelectric ceramic driving member. The metal wire is fixed to the base, and the piezoelectric ceramic driving member is connected to a free end of the metal wire. The piezoelectric ceramic driving member is substantially parallel to the force-bearing portion.

In some embodiments, the piezoelectric ceramic driving member applies the pushing force to the force-bearing portion. An acute angle is formed between a pushing direction of the pushing force and a movement direction of the resisting portion from the start position toward the contact position.

In some embodiments, the driving member includes a shape memory alloy wire. The shape memory alloy wire is obliquely connected to the force-bearing portion of the driven member. The shape memory alloy wire applies the pushing force to the force-bearing portion, and a pushing direction of the pushing force is substantially parallel to a movement direction of the resisting portion from the start position toward the contact position.

In some embodiments, an inclined surface of a tooth of one of the first track and the second track is substantially parallel to the shape memory alloy wire.

In some embodiments, the first track and the second track of the rotating plate are respectively a first toothed ratchet track and a second toothed ratchet track. The first toothed ratchet track corresponds to the first driving module, and the second toothed ratchet track corresponds to the second driving module. A toothed direction of the first toothed ratchet track is opposite to a toothed direction of the second toothed ratchet track. An inner diameter of the first toothed ratchet track is less than an inner diameter of the second toothed ratchet track.

In some embodiments, teeth of the first toothed ratchet track and the second toothed ratchet track are straight teeth.

In some embodiments, the first track and the second track of the rotating plate are respectively a first friction track and a second friction track, and an inner diameter of the first friction track is less than an inner diameter of the second friction track.

In some embodiments, the variable aperture assembly further includes a magnetic ring and a Hall sensor. The magnetic ring is located on the rotating plate. The magnetic ring has a plurality of magnetic blocks. Polarity directions of two adjacent magnetic blocks are opposite. A width of each magnetic block corresponds to one stroke of the rotating plate. In addition, the Hall sensor is located on the base. The Hall sensor is configured to sense a change in a rotational position of the rotating plate.

In some embodiments, an inner side of the rotating plate has a stopping surface and a sliding surface. An inclined angle of the sliding surface is less than an inclined angle of the stopping surface, and the stopping surface is in contact with an outer side surface of the base.

In some embodiments, the first driving module and the second driving module each further include a controller connected to the driving member. The controller is configured to alternately power on and power off the driving member to control the driving member to generate the pushing force.

According to another aspect, some embodiments of the present disclosure further provides a lens module, including a lens and the foregoing variable aperture assembly. The variable aperture assembly is disposed on the lens, and the variable aperture assembly is configured to control an amount of light entering the lens.

In conclusion, in some embodiments, the variable aperture assembly or the lens module thereof employs the lever-based driving mechanism that generates the force suitable for driving a relatively larger number of blades, and the force also provides a relatively long stroke to the rotating plate, thereby meeting the structural design requirements of electronic devices. In addition, the variable aperture assembly has a simple structure and is conveniently manufactured.

The following describes the present disclosure in detail with reference to accompanying drawings and specific embodiments, but is not intended to limit the present disclosure.

### BRIEF DESCRIPTION OF THE DRAWINGS

FIG. 1 is a schematic perspective view of a lens module according to some embodiments, an entering direction of an incident light being displayed by a dashed-line arrow;

FIG. 2 is a schematic perspective view of a variable aperture assembly according to some embodiments;

FIG. 3 is a schematic exploded view of a variable aperture assembly according to some embodiments;

FIG. 4 is a schematic bottom view of a variable aperture assembly according to some embodiments, without displaying a base;

FIG. 5 is a schematic perspective view of a rotating plate according to some embodiments;

FIG. 6 is a schematic enlarged diagram of a position of a marked region B in FIG. 5;

FIG. 7 is a schematic cross-sectional diagram of a position marked by 7-7 in FIG. 2 and shows a partial schematic enlarged diagram of a position marked by a point-link line;

FIG. 8 is a schematic enlarged diagram of a position of a marked region A in FIG. 2, a movement direction of a resisting portion from a start position to a contact position being represented by a dashed arrow;

FIG. 9A is a schematic perspective view of a driven member according to some embodiments;

FIG. 9B is a schematic top view of a driven member of a second driving module according to some embodiments;

FIG. 9C is a schematic top view of a driven member of a first driving module according to some embodiments;

FIG. 10 is a schematic enlarged diagram of a position of a marked region C in FIG. 8, a part of a second track being displayed in gray, a solid-line gray block representing that a resisting portion is located at a start position, and a dashed-line white block representing that the resisting portion is located at a contact position;

FIG. 11 is a partial schematic enlarged diagram of a rotating plate and a driven member according to some embodiments, the driven member being located at a start position;

FIG. 12 is a partial schematic enlarged diagram of a rotating plate, a driving member, and a driven member according to some embodiments; and

FIG. 13 is a partial schematic enlarged diagram of a magnetic ring, a rotating plate, and a Hall sensor according to some embodiments, the rotating plate being represented by a dashed line.

### DETAILED DESCRIPTION

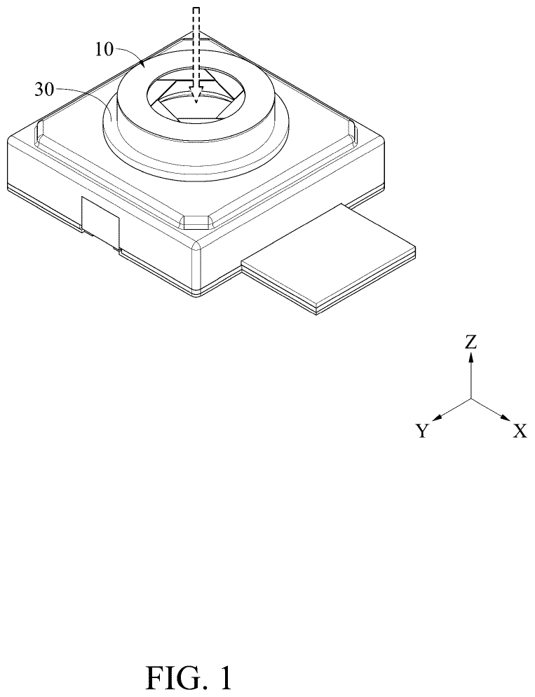

Referring to FIG. 1, FIG. 1 is a schematic perspective view of a lens module according to some embodiments, an entering direction of an incident light being displayed by a dashed-line arrow. A lens module has a lens 30 and a variable aperture assembly 10. The lens module is configured to be disposed in an electronic device (not shown), such as a camera, a mobile phone, a tablet computer, a notebook computer, a wearable electronic device, a smart watch, an augmented reality (AR) device, a virtual reality (VR) device, or a device having a camera function. In addition, the variable aperture assembly 10 is disposed on the lens 30, and the variable aperture assembly 10 is configured to control an amount of light entering the lens 30. For example, when photographing is performed at night, ambient light is relatively dark, and the variable aperture assembly 10 can be controlled to increase an aperture, so that the amount of light entering the lens 30 increases, thereby improving imaging quality of the lens module.

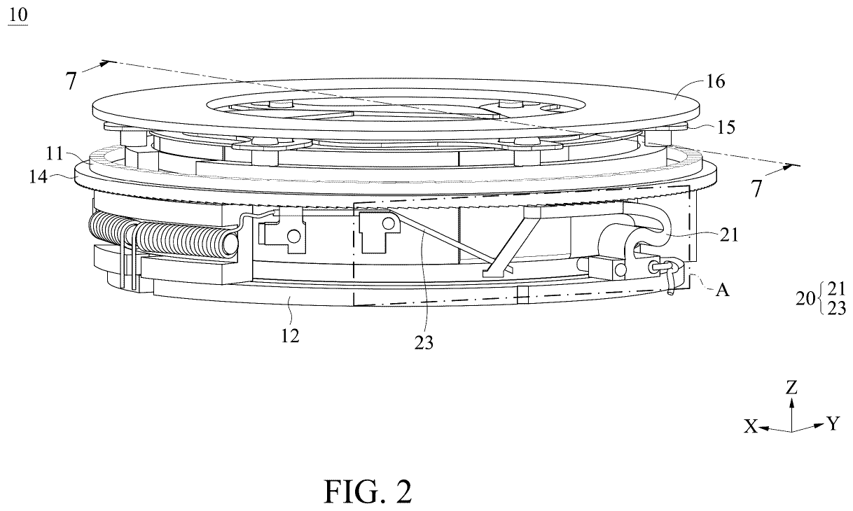

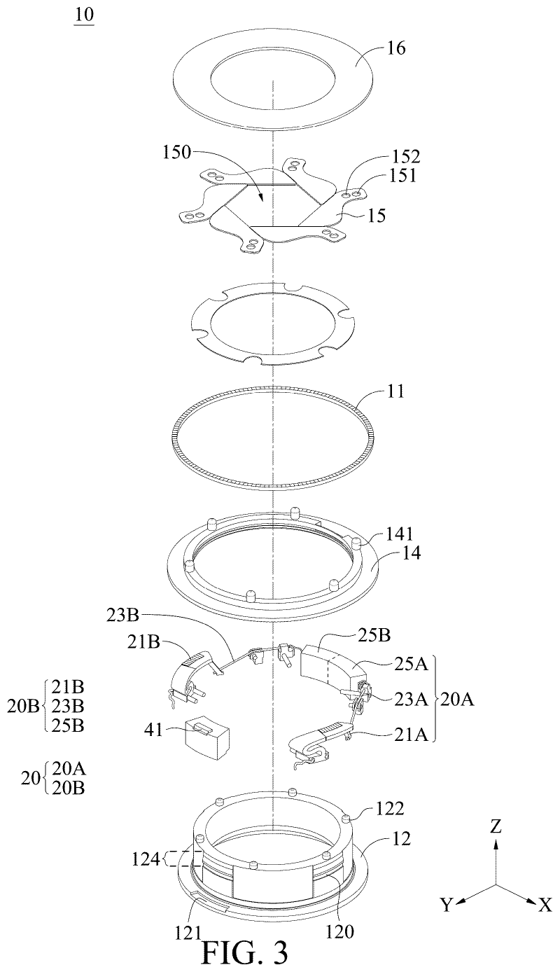

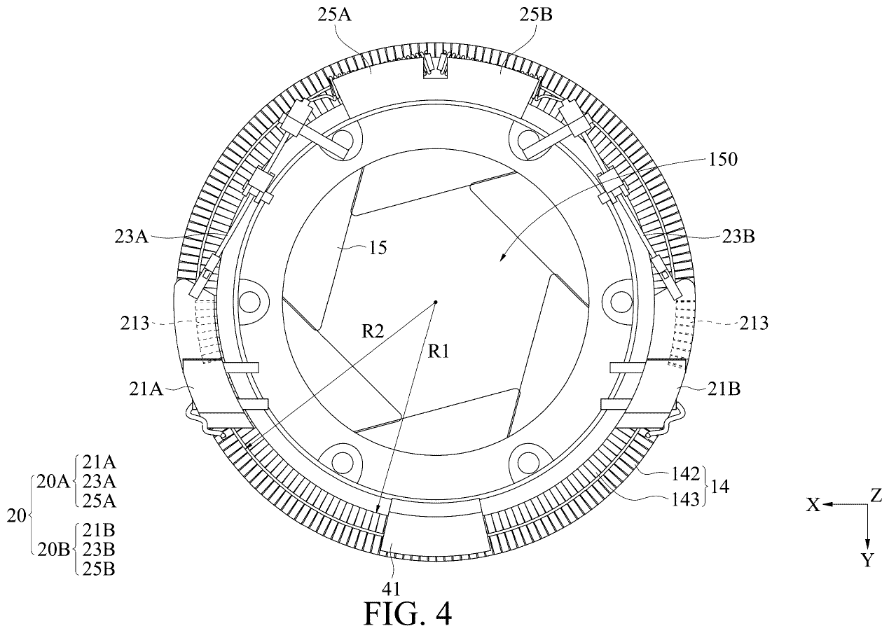

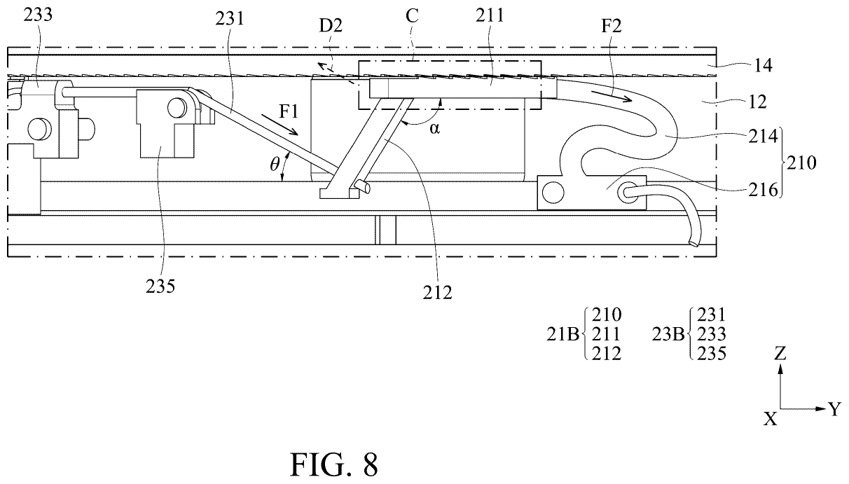

Referring to FIG. 2, FIG. 3, FIG. 4, and FIG. 8, FIG. 2 is a schematic perspective view of the variable aperture assembly 10 according to some embodiments; FIG. 3 is a schematic exploded view of the variable aperture assembly 10 according to some embodiments; FIG. 4 is a schematic bottom view of the variable aperture assembly 10 according to some embodiments, without displaying a base 12; and FIG. 8 is a schematic enlarged diagram of a position of a marked region A in FIG. 2, a movement direction D2 of a resisting portion 211 from a start position P1 to a contact position P2 being represented by a dashed arrow.

The variable aperture assembly 10 has the base 12, a plurality of blades 15, a rotating plate 14, and two driving modules 20. The two driving modules 20 are the first driving module 20A and the second driving module 20B shown in FIG. 3, and are respectively disposed on two sides of the base 12. Referring to FIG. 3, the rotating plate 14 is located between the base 12 and the blades 15. The blades 15 are annularly disposed on the base 12 and form the aperture hole 150. The blades 15 are connected to the rotating plate 14. Referring to FIG. 4, the rotating plate 14 is provide with two tracks respectively corresponding to the two driving modules 20. The two driving modules 20 employ lever-based mechanisms that respectively drive the rotating plate 14 to rotate in opposite directions, to control a size of the aperture hole 150. Specifically, referring to FIG. 4, the first driving module 20A corresponds to the first track 143 of the rotating plate 14, and the second driving module 20B corresponds to the second track 142 of the rotating plate 14. The first driving module 20A and the second driving module 20B are configured to leveragingly drive the rotating plate 14 to respectively rotate in opposite directions, to drive the blades 15 to correspondingly move. For example, the first driving module 20A drives the rotating plate 14 to rotate counterclockwise from the viewing angle of FIG. 4. The blades 15 correspondingly move centripetally such that the aperture hole 150 becomes smaller. The second driving module 20B drives the rotating plate 14 to rotate clockwise from the viewing angle of FIG. 4. The blades 15 correspondingly move eccentrically such that the aperture hole 150 becomes larger. It should be noted that, the first track 143 and the second track 142 of the rotating plate 14 may be, but are not limited to, two adjacent inner and outer ring tracks (as shown in FIG. 4), or two tracks respectively located at different positions on the bottom surface of the rotating plate 14, and the tracks are pushed to rotate in opposite directions.

Referring to FIG. 2, each driving module 20 has a driving member 23 and a driven member 21. The driving member 23 and the driven member 21 are both disposed on the base 12. Referring to FIG. 8, the driven member 21 has a stress-bearing portion 210 fixed to the base 12. When the driving member 23 is controlled to apply a pushing force F1 to the driven member 21, the stress-bearing portion 210 correspondingly generates a restoring force F2. The pushing force F1 and the restoring force F2 cooperatively drive the driven member 21 to contact the first track 143 or the second track 142 of the rotating plate 14. Therefore, the variable aperture assembly 10 employs the lever-based driving mechanism that generates the force (e.g. pulling force) suitable for driving a relatively larger number of blades 15, and the force also provides a relatively long stroke, thereby meeting the structural design requirements of electronic devices. In addition, the variable aperture assembly 10 has a simple structure and is conveniently manufactured.

Further, structures of elements in the variable aperture assembly 10 are described below.

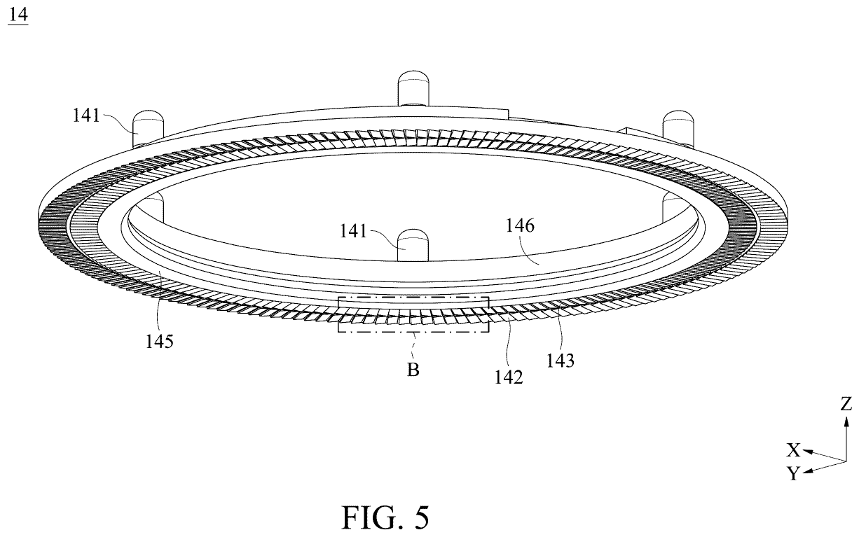

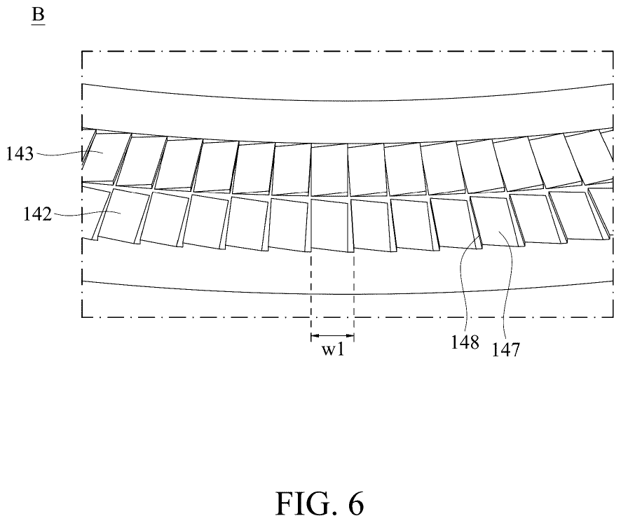

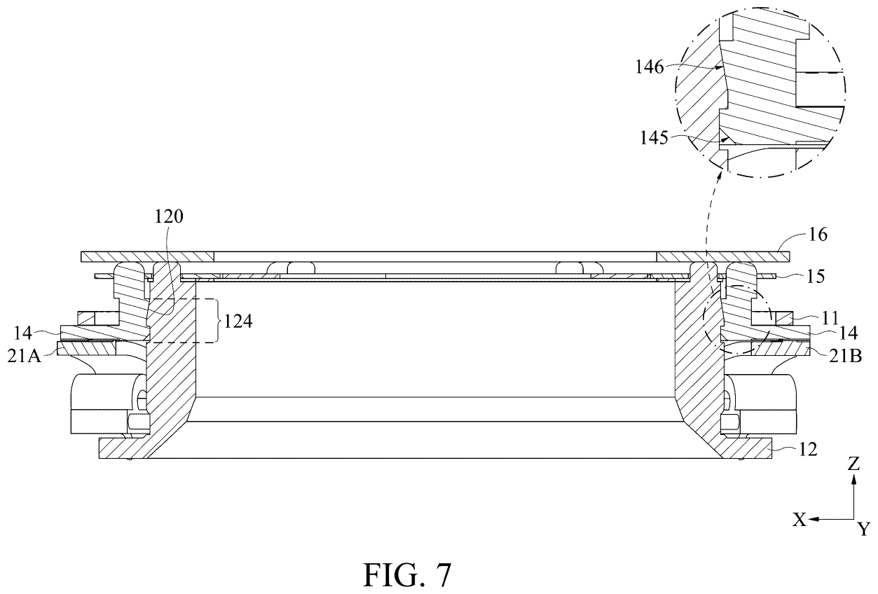

Referring to FIG. 5, FIG. 6, and FIG. 7, FIG. 5 is a schematic perspective view of the rotating plate 14 according to some embodiments; FIG. 6 is a schematic enlarged diagram of a position of a marked region B in FIG. 5; and FIG. 7 is a schematic cross-sectional diagram of a position marked by 7-7 in FIG. 2 and shows a partial schematic enlarged diagram of a position marked by a point-link line.

Referring to FIG. 3, in some embodiments, a cover plate 16 is located on a side of the base 12. A side on which the cover plate 16 is located is referred to as “top” or “upper”, and another opposite side is referred to as “bottom” or “lower”. The rotating plate 14 is located on the outer side surface of the base 12, and the top surface of the base 12 is provided with a plurality of short shafts 122. The top surface of the rotating plate 14 is provided with a plurality of positioning columns 141. One positioning column 141 and one short shaft 122 correspond to one blade 15. Specifically, one end of each blade 15 is provided with a positioning hole 151 and a shaft hole 152. Compared with the shaft hole 152, the positioning hole 151 is closer to the outer edge of the blade 15. The positioning column 141 of the rotating plate 14 is located in the positioning hole 151, and the short shaft 122 of the base 12 is located in the shaft hole 152. Therefore, each blade 15 moves centripetally or eccentrically about the short shaft 122 as a pivot, so as to control the size of the aperture hole 150.

Referring to FIG. 3 and FIG. 7, in some embodiments, an engaging portion 124 of the base 12 externally protrudes from the outer side surface of the base 12. The engaging portion 124 may be annularly disposed on the outer side surface of the base 12, or may comprise a plurality of segment portions uniformly disposed on the outer side surface of the base 12. The inner side of the rotating plate 14 is provided with two sets of inclined surface structures. Specifically, referring to FIG. 5, the first set of inclined surface structure has a sliding surface 145 connected to the bottom surface of the rotating plate 14. The second set of inclined surface structure has a stopping surface 146. The stopping surface 146 is located above the sliding surface 145. Referring to FIG. 7, the sliding surface 145 is located in a groove 120 of the engaging portion 124, and the stopping surface 146 is in contact with the outer side surface of the base 12. In addition, an inclined angle of the sliding surface 145 is less than an inclined angle of the stopping surface 146. The inclined angle is defined by the sliding surface 145 (or the stopping surface 146) and the X axis in FIG. 7. When the rotating plate 14 is sleeved onto the base 12 from the top, the sliding surface 145 of the first set of inclined surface structure may facilitate assembly, while the stopping surface 146 is configured to position the rotating plate 14 and guide the rotation of the rotating plate 14.

Referring to FIG. 3 and FIG. 4, in some embodiments, the first driving module 20A has a controller 25A, a driving member 23A, and a driven member 21A. Similarly, the second driving module 20B has a controller 25B, a driving member 23B, and a driven member 21B. The controller 25A and the controller 25B may be, but are not limited to, smooth impact driving mechanism (SIDM) actuators, or other linear actuators. Configuration and action of the first driving module 20A and the second driving module 20B are the same. Descriptions are provided below by taking the second driving module 20B as an example. The controller 25B is connected to the driving member 23B. The controller 25B is configured to alternately power on and power off the driving member 23B to control the driving member 23B to generate the pushing force F1 (shown in FIG. 8). Specifically, referring to FIG. 8, when the controller 25B powers on the driving member 23B, the driving member 23A is correspondingly deformed to generate the pushing force F1. The driven member 21B is in contact with the rotating plate 14 under the pushing force F1, and correspondingly generates the restoring force F2. When the controller 25B powers off the driving member 23B, the restoring force F2 drives the driven member 21B moving away from the rotating plate 14.

The structures of the rotating plate 14, the driven member 21, and the driving member 23 are described in the following embodiments.

Referring to FIG. 5, in some embodiments, the first track 143 and the second track 142 are located on the bottom surface of the rotating plate 14. Referring to FIG. 4, the inner diameter R1 of the first track 143 is less than the inner diameter R2 of the second track 142, and the first track 143 as well as the second track 142 are two adjacent circular tracks. It should be noted that, the first track 143 and the second track 142 may alternatively be two arc-shaped tracks respectively located at different parts of the rotating plate 14. The inner diameter R1 of the first track 143 is the same as or different from the inner diameter R2 of the second track 142.

Referring to FIG. 6, in some embodiments, the first track 143 and the second track 142 are both toothed ratchet tracks. The teeth of the first track 143 and the second track 142 both are involute teeth, wherein the tooth types of the first track 143 and the second track 142 are respectively positive and negative involutes. Therefore, during the rotation of the rotating plate 14, each tooth contact point is maintained at a constant velocity, thereby reducing wear and noise of the tooth surfaces, and improving efficiency and service life of the variable aperture assembly 10. Teeth of the first track 143 and the second track 142 both include, but are not limited to, straight teeth, helical teeth, serrated teeth, or bi-directionally pushable teeth.

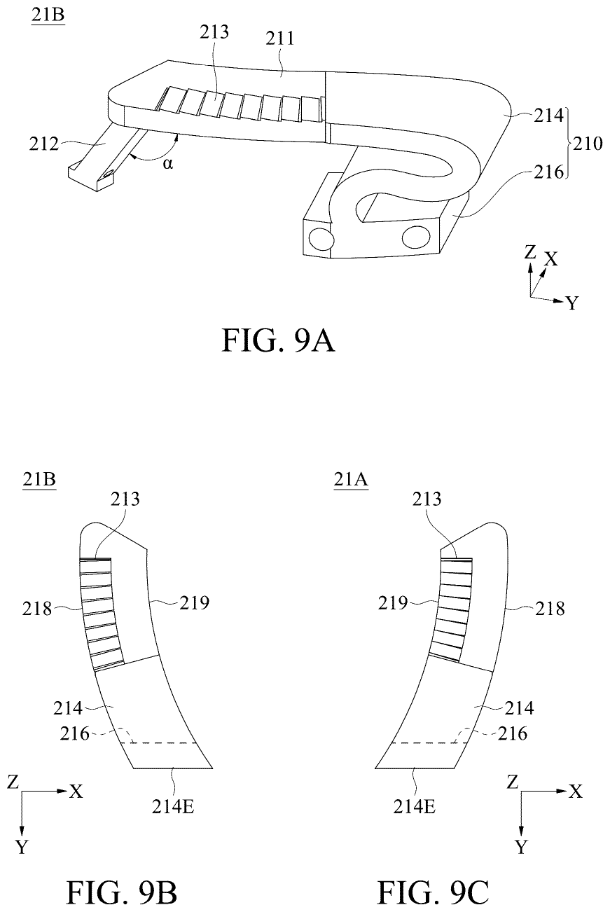

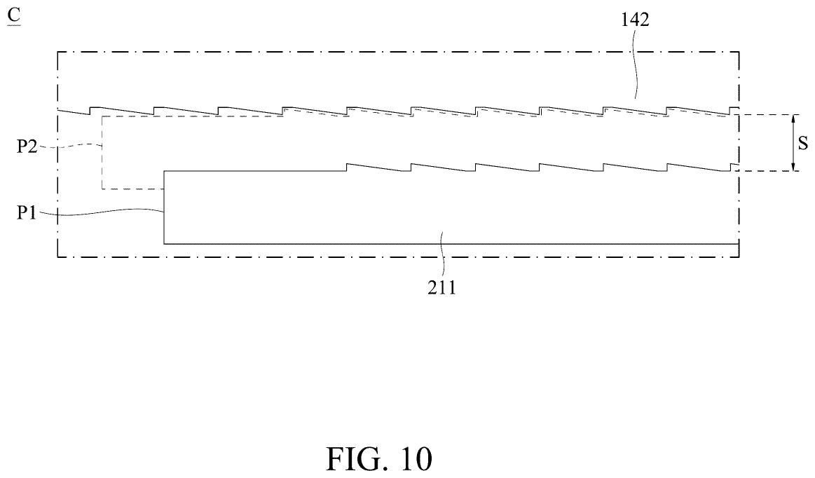

Referring to FIG. 9A, FIG. 9B, FIG. 9C, and FIG. 10, FIG. 9A is a schematic perspective view of the driven member 21B of the second driving module 20B according to some embodiments; FIG. 9B is a schematic top view of the driven member 21B of the second driving module 20B according to some embodiments; FIG. 9C is a schematic top view of the driven member 21A of the first driving module 20A according to some embodiments; and FIG. 10 is a schematic enlarged diagram of a position of a marked region C in FIG. 8, a part of the second track 142 being displayed in gray, a solid-line gray block representing that the resisting portion 211 is located at the start position P1, and a dashed-line white block representing that the resisting portion 211 is located at the contact position P2.

In some embodiments, the driven member 21A and the driven member 21B each have a force-bearing portion 212, a resisting portion 211, and a stress-bearing portion 210. The resisting portion 211 is connected to the force-bearing portion 212 and the stress-bearing portion 210. The stress-bearing portion 210 has a curved section 214 and a fixed section 216. One end of the curved section 214 is extensively connected to the resisting portion 211, and the other end of the curved section 214 is connected to the fixed section 216. The fixed section 216 is fixed to the base 12 through locking members (such as tenons, hooks or screws). The curved section 214 may be, but is not limited to, in S-shape, in C-shape, or in “>” shape. In some embodiments, referring to FIG. 9B, and FIG. 9C a projection of an end edge 241E of the curved section 214 along Z direction is outside a projection of the fixed section 216, such that it can save space. In some embodiments, the angle α exists between the force-bearing portion 212 and the resisting portion 211. Preferably, in some embodiments, the angle α is at least 90 degrees and less than 180 degrees. In some embodiments, the angle α is between 120 degrees and less than 150 degrees. In addition, the resisting portion 211 is a portion parallel to the bottom surface of the rotating plate 14 (shown FIG. 8). The contact section 213 of the resisting portion 211 is a portion at which the resisting portion 211 is in contact with the corresponding track. For example, referring to FIG. 4, the driven member 21A and the driven member 21B respectively correspond to the first track 143 and the second track 142. The contact section 213 of the driven member 21A is located at the inner edge 219 of the resisting portion 211 shown in FIG. 9C. The contact section 213 of the driven member 21B is located at the outer edge 218 of the resisting portion 211 shown in FIG. 9B.

The action relationship between the driven member 21 and the corresponding track are described in the following embodiments. The second driving module 20B is described as an example. Referring to FIG. 10, in some embodiments, when the driven member 21B is not subjected to force, the resisting portion 211 is located at the start position P1, and a gap S exists between the resisting portion 211 and the rotating plate 14. Referring to FIG. 8, when the driving member 23B applies the pushing force F1 to the force-bearing portion 212, the resisting portion 211 is moved to the contact position P2 (shown in FIG. 10) and is in contact with the corresponding track, thereby pushing the rotating plate 14 to rotate. At this time, the curved section 214 generates the restoring force F2. When the pushing force F1 disappears or the restoring force F2 is greater than the pushing force F1, the resisting portion 211 moves from the contact position P2 toward the start position P1, and moves away from the rotating plate 14. In the result, one stroke is completed.

The following describes other embodiments of variant applications.

In some embodiments, referring to FIG. 6, teeth of the first track 143 and the second track 142 are straight teeth. Each tooth has the inclined surface 147 and the stopping surface 148, which are joined to form a right triangle (i.e., the projection of the inclined surface 147, the stopping surface 148 and X-Y plane on the Y-Z plane shown in FIG. 5 forms the right triangle). The inclined direction of the inclined surface 147 of the first track 143 is opposite to the inclined direction of the inclined surface 147 of the second track 142. For example, the inclined surface 147 of the first track 143 is oriented to the upper left from the viewing angle of FIG. 6, and the inclined surface 147 of the second track 142 is oriented to the upper right from the viewing angle of FIG. 6, and the two inclined directions are opposite. In some embodiments, the toothed direction of the first track 143 is the forward direction, and the toothed direction of the second track 142 is the backward direction. Therefore, the first track 143 or the second track 142 may be pushed and driven by the corresponding driven member 21 in a single direction, to avoid slip phenomenon between the driven member 21 and the corresponding track. Referring to FIG. 4 and FIG. 6, in some embodiments, take the driven member 21A of the first driving module 20A as an example, after the driven member 21A is in contact with the inclined surface 147 of each tooth and slides from one end to the other end of the inclined surface 147, the driven member 21A pushes against the stopping surface 148 of each tooth to drive the rotating plate 14 to rotate in one single direction. That is, after the stopping surface 148 of the first track 143 is pushed, the rotating plate 14 rotates clockwise from the viewing angle of FIG. 4, and the blades 15 move eccentrically.

Referring to FIG. 6 and FIG. 8, in some embodiments, the movement direction D2 of the resisting portion 211 from the start position P1 toward the contact position P2 is substantially parallel to the inclined surface 147 of the tooth of the rotating plate 14. For example, the movement direction D2 shown in FIG. 8 is parallel to the inclined surface 147 of the second track 142 shown in FIG. 6.

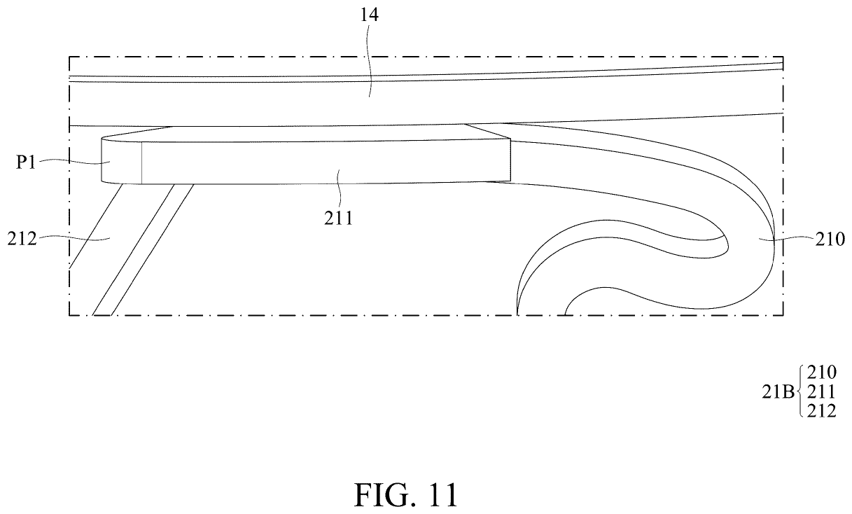

Referring to FIG. 11, FIG. 11 is a partial schematic enlarged diagram of the rotating plate 14 and the driven member 21 according to some embodiments, which shows that the driven member 21 is located at the start position P1. In some embodiments, the rotating plate 14 may alternatively be a friction wheel without teeth. To be specific, in this embodiment, the first track 143 and the second track 142 may be respectively a first friction track and a second friction track. The two friction tracks are, for example, but are not limited to, tracks having uneven structures (concave-convex structures) without any tooth profile or having non-smooth friction surfaces. The structures of the driven member 21A and the driven member 21B in this embodiment are similar to the structures shown in FIG. 9A to FIG. 9C, and a difference lies in that the contact section 213 has a uneven structure without any tooth profile or a non-smooth friction surface. Action between the driven member 21A as well as the driven member 21B and the corresponding tracks is similar to that in the foregoing embodiments, and a difference lies in that the rotation of the rotating plate 14 is driven by the friction force between the contact section 213 and the corresponding track. Therefore, because the rotation of the rotating plate 14 is driven by friction force, a magnitude of the friction force may be determined by the material of the driven member 21 and the normal force applied thereto, without being limited by the number of teeth, thereby providing design flexibility.

Referring to FIG. 8, in some embodiments, the first driving module 20A and the second driving module 20B apply the driving mechanism with shape memory alloy (SMA). Using the second driving module 20B as an example, the driving member 23B has a shape memory alloy wire 231 and a fixing block 233. The fixing block 233 is disposed on the outer side surface of the base 12. One end of the shape memory alloy wire 231 is connected to the fixing block 233, and the other end of the shape memory alloy wire 231 is obliquely connected to the force-bearing portion 212 of the driven member 21B. The shape memory alloy wire 231 and the force-bearing portion 212 are jointed in approximately V-shaped. Preferably, in some embodiments, an inclined angle θ of the shape memory alloy wire 231 is less than or equal to 45 degrees. In some embodiments, the inclined angle θ of the shape memory alloy wire 231 is less than or equal to 30 degrees. In addition, the shape memory alloy wire 231 applies the pushing force F1 to the force-bearing portion 212, and the pushing direction of the pushing force F1 is substantially parallel to the movement direction D2 of the resisting portion 211 from the start position P1 toward the contact position P2. According to the lever principle, the stress-bearing portion 210 serves as the fulcrum of the lever. The pushing force F1 is applied to the force-bearing portion 212, wherein the direction of the pushing force F1 is not parallel to the resisting portion 211. Therefore, the pushing force F1 (the position where the pushing force F1 is applied) and the fulcrum (the stress-bearing portion 210) are respectively located at two ends of the driven member 21B, which is a force-saving leverage structure. In addition, through lever-based mechanism, the force for driving the blades 15 may be increased. In some embodiments, referring to FIG. 4 and FIG. 8, the controller 25A and the controller 25B may control the shape memory alloy wire 231 to perform deformation (elongation and/or contraction). The elongation and contraction rate of the shape memory alloy wire 231 ranges from 2% to 10%. In some embodiments, the elongation and contraction rate of the shape memory alloy wire 231 is 2%, and a length of the shape memory alloy wire 231 is 2 mm. Although the length variation of the shape memory alloy wire 231 is only 0.04 mm, the shape memory alloy wire 231 is capable of generating a stroke of 0.2 mm in the rotating plate 14 via the lever-based mechanism in the above embodiments. In addition, in some embodiments, the driving member 23B may further have a sliding block 235. The sliding block 235 is located between the fixing block 233 and the force-bearing portion 212, and the shape memory alloy wire 231 is located in a notch of the sliding block 235. When the shape memory alloy wire 231 contracts, the sliding block 235 also moves accordingly.

In this way, the lever-based mechanism formed by the shape memory alloy wire 231 and the driven member 21 may amplify the pulling force applied to the blades 15 by more than ten times. Therefore, the variable aperture assembly 10 may be applied to the lens module with more functional designs.

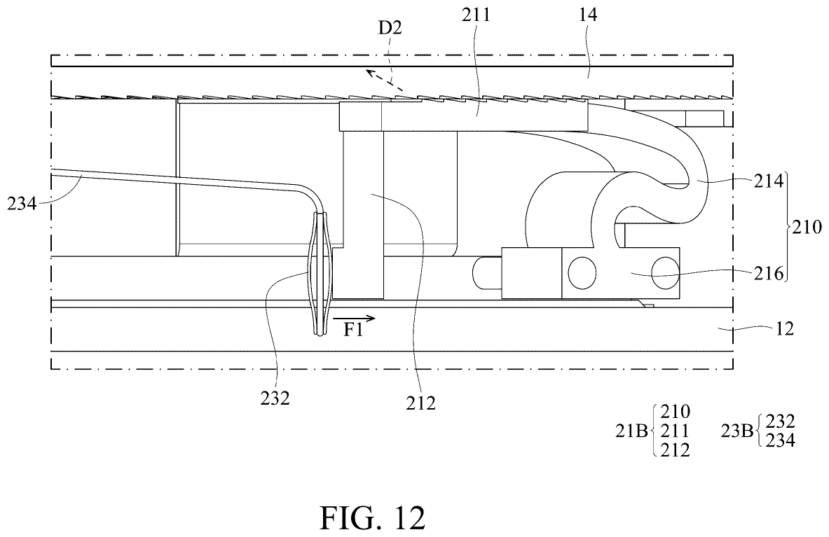

In addition, referring to FIG. 12, FIG. 12 is a partial schematic enlarged diagram of the rotating plate 14, the driving member 23, and the driven member 21 according to some embodiments. In some embodiments, the first driving module 20A and the second driving module 20B adopt driving mechanism with piezoelectric ceramic material. Using the second driving module 20B as an example, the driving member 23B includes a metal wire 234 and a piezoelectric ceramic driving member 232. One end of the metal wire 234 is fixed to the base 12, and the other end of the metal wire 234 is a free end connected to the piezoelectric ceramic driving member 232. The piezoelectric ceramic driving member 232 is adjacent to the force-bearing portion 212, and the piezoelectric ceramic driving member 232 is substantially parallel to the force-bearing portion 212. In some embodiments, when the controller 25B (shown in FIG. 4) does not power on the metal wire 234, the piezoelectric ceramic driving member 232 may be in contact with the force-bearing portion 212 or a gap may exist between the piezoelectric ceramic driving member 232 and the force-bearing portion 212. When the metal wire 234 is powered on, the piezoelectric ceramic driving member 232 is deformed. The piezoelectric ceramic driving member 232 is in contact with the force-bearing portion 212 and applies the pushing force F1 to the force-bearing portion 212. The pushing direction of the pushing force F1 is not parallel to the movement direction D2 of the resisting portion 211 from the start position P1 toward the contact position P2. That is, an acute angle is formed between the pushing direction of the pushing force F1 and the movement direction D2. The levered-based mechanism of this embodiment is the same as that of the foregoing embodiments, and details are not described again. It should be noted that, this embodiment adopts the piezoelectric ceramic driving member 232, which has advantages such as a small volume, a simple structure, without form limitations, a high power density, non-flammability, and being unaffected by electromagnetic interference. In addition, the piezoelectric ceramic driving member 232 does not need to be wired by a coil. Therefore, problems such as electromagnetic interference, leakage induction, and low-frequency noise can be avoided, and the piezoelectric ceramic driving member 232 is light, practical, and secure.

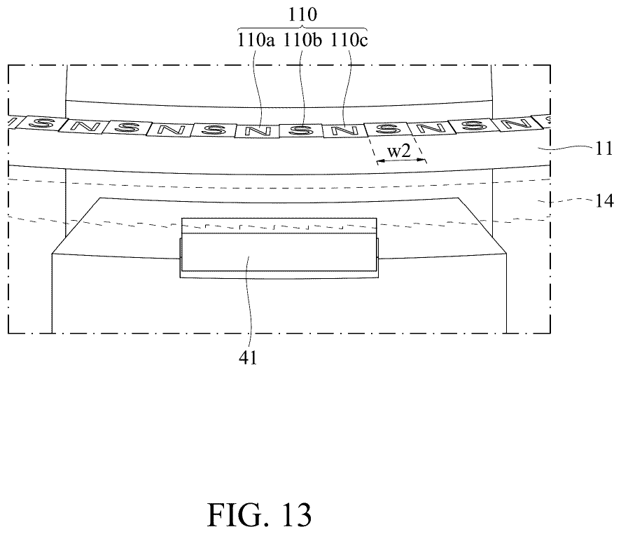

Referring to FIG. 2, FIG. 3, and FIG. 13, FIG. 13 is a partial schematic enlarged diagram of a magnetic ring 11, the rotating plate 14, and a Hall sensor 41 according to some embodiments, the rotating plate 14 being represented by a dashed line. In some embodiments, the variable aperture assembly 10 further includes the magnetic ring 11 and the Hall sensor 41. The magnetic ring 11 is located on the top surface of the rotating plate 14. The Hall sensor 41 is located on a sensor fixing portion 121 (shown in FIG. 3) of the base 12. The Hall sensor 41 is configured to sense a change in a rotational position of the rotating plate 14. Specifically, referring to FIG. 13, the magnetic ring 11 has a plurality of magnetic blocks 110, and the width w2 of each magnetic block 110 corresponds to one stroke of the rotating plate 14. In addition, two adjacent magnetic blocks 110 have opposite polarities. Using FIG. 13 as an example, the magnetic block 110b has an S-pole, and the magnetic blocks 110a and 110c adjacent to the magnetic block 110b have an N-pole. Because the Hall sensor 41 is located outside the magnetic field of the magnetic ring 11, the magnetic field change (the magnetic field) of the magnetic ring 11 will affect the electronic movement of the Hall sensor 41, so that a potential difference is generated in the Hall sensor 41. The potential difference may be converted into a voltage signal or a current signal for a control unit (for example, a circuit board) to read or process. For example, when the rotating plate 14 is pushed to rotate by one stroke, the magnetic ring 11 is correspondingly driven to rotate by one stroke as well, and the Hall sensor 41 generates the correspondingly voltage signal or the current signal. Thus, the rotational position change of the rotating plate 14 can be sensed, and the accuracy of the stroke of the rotating plate 14 can be verified.

Referring to FIG. 6 and FIG. 13, in some embodiments, the width w2 of each magnetic block 110 corresponds to the interval w1 (shown in FIG. 6) between each tooth on the rotating plate 14. For example, if the fully open angle of the blades 15 is 45 degrees (the maximum rotation angle), and the teeth of the first track 143 as well as the second track 142 are straight teeth shown in FIG. 6, the interval between each tooth on the rotating plate 14 may be set to 1.8 degrees. The first track 143 and the second track 142 may each have a total of 200 teeth. Thus, fully opening the blades 15 requires 25 strokes. Correspondingly, the width w2 of each magnetic block 110 is also 1.8 degrees, so as to correspond to movement of each stroke of the rotating plate 14.

Certainly, the present disclosure may have various other embodiments. Without departing from the spirit of the present disclosure and its essence, a person skilled in the art may make various corresponding changes and modifications according to the present disclosure, but these corresponding changes and modifications shall fall within the protection scope of the claims of the present disclosure.

What is claimed is:

1. A variable aperture assembly, comprising:
a base;
a plurality of blades, annularly disposed on the base;
a rotating plate, located between the base and the blades, the blades being connected to the rotating plate, and the rotating plate having a first track and a second track;
a first driving module, corresponding to one of the first track and the second track; and
a second driving module, corresponding to the other one of the first track and the second track, wherein the first driving module and the second driving module are configured to leveragingly drive the rotating plate to respectively rotate in opposite directions, to drive the blades to correspondingly move, and the first driving module and the second driving module each comprising:
a driving member, disposed on the base; and
a driven member, disposed on the base, the driven member comprising a stress-bearing portion fixed to the base, wherein when the driving member is controlled to apply a pushing force to the driven member, the stress-bearing portion correspondingly generates a restoring force, and the pushing force and the restoring force cooperatively drive the driven member to contact one of the first track and the second track.

2. The variable aperture assembly according to claim 1, wherein the driven member further comprises:
a force-bearing portion, the driving member applying the pushing force to the force-bearing portion; and
a resisting portion, connected to the force-bearing portion and the stress-bearing portion, the resisting portion being parallel to the rotating plate, the stress-bearing portion having a curved section, and the curved section generating the restoring force, wherein the pushing force and the restoring force cooperatively drives the resisting portion to have a start position and a contact position; and wherein when the resisting portion is located at the contact position, the resisting portion is in contact with one of the first track and the second track; and when the resisting portion is located at the start position, a gap exists between the resisting portion and the rotating plate.

3. The variable aperture assembly according to claim 2, wherein one end of the curved section is extensively connected to the resisting portion, and the other end of the curved section is fixed to the base.

4. The variable aperture assembly according to claim 2, wherein the driving member comprises:
a metal wire, fixed to the base; and
a piezoelectric ceramic driving member, connected to a free end of the metal wire, the piezoelectric ceramic driving member being substantially parallel to the force-bearing portion.

5. The variable aperture assembly according to claim 4, wherein the piezoelectric ceramic driving member applies the pushing force to the force-bearing portion, and an acute angle being formed between a pushing direction of the pushing force and a movement direction of the resisting portion from the start position toward the contact position.

6. The variable aperture assembly according to claim 2, wherein the driving member comprises:
a shape memory alloy wire, obliquely connected to the force-bearing portion of the driven member, the shape memory alloy wire applying the pushing force to the force-bearing portion, and a pushing direction of the pushing force being substantially parallel to a movement direction of the resisting portion from the start position toward the contact position.

7. The variable aperture assembly according to claim 6, wherein an inclined surface of a tooth of one of the first track and the second track is substantially parallel to the shape memory alloy wire.

8. The variable aperture assembly according to claim 6, wherein an inclined angle of the shape memory alloy wire is less than or equal to 45 degrees.

9. The variable aperture assembly according to claim 2, wherein an angle is formed between the force-bearing portion and the resisting portion, and the angle is at least 90 degrees and less than 180 degrees.

10. The variable aperture assembly according to claim 2, wherein a projection of an end edge of the curved section is outside a projection of the fixed section.

11. The variable aperture assembly according to claim 2, wherein the stress-bearing portion and the position where the pushing force is applied are respectively located at two ends of the driven member.

12. The variable aperture assembly according to claim 1, wherein the first track and the second track of the rotating plate are respectively a first toothed ratchet track and a second toothed ratchet track, the first toothed ratchet track corresponds to the first driving module, the second toothed ratchet track corresponds to the second driving module; and wherein a toothed direction of the first toothed ratchet track is opposite to a toothed direction of the second toothed ratchet track, and an inner diameter of the first toothed ratchet track is less than an inner diameter of the second toothed ratchet track.

13. The variable aperture assembly according to claim 12, wherein teeth of the first toothed ratchet track and the second toothed ratchet track are straight teeth.

14. The variable aperture assembly according to claim 1, wherein the first track and the second track of the rotating plate are respectively a first friction track and a second friction track, and an inner diameter of the first friction track is less than an inner diameter of the second friction track.

15. The variable aperture assembly according to claim 1, further comprising:
a magnetic ring, located on the rotating plate, the magnetic ring having a plurality of magnetic blocks, wherein polarity directions of two adjacent magnetic blocks are opposite; and
a Hall sensor, located on the base and configured to sense a change in a rotational position of the rotating plate.

16. The variable aperture assembly according to claim 15, wherein a width of each magnetic block corresponds to one stroke of the rotating plate.

17. The variable aperture assembly according to claim 15, wherein a width of each magnetic block corresponds to an interval between each tooth on the rotating plate.

18. The variable aperture assembly according to claim 1, wherein an inner side of the rotating plate has a stopping surface and a sliding surface, an inclined angle of the sliding surface is less than an inclined angle of the stopping surface, and the stopping surface is in contact with an outer side surface of the base.

19. The variable aperture assembly according to claim 1, wherein the first driving module and the second driving module each further comprise a controller connected to the driving member, and the controller is configured to alternately power on and power off the driving member to control the driving member to generate the pushing force.

20. A lens module, comprising:
a lens; and
the variable aperture assembly according to claim 1, disposed on the lens, wherein the variable aperture assembly is configured to control an amount of light entering the lens.
